(19) United States
(12) Patent Application Publication
(10) Pub. No.: US 2018/0015692 A1
(43) Pub. Date: Jan. 18, 2018

(54) Geometric Structural Assembly

(71) Applicant: Peter Mackie, New York, NY (US)

(72) Inventor: Peter Mackie, New York, NY (US)

(21) Appl. No.: 15/211,861

(22) Filed: Jul. 15, 2016

(51) Int. Cl. B32B 7/08

(52) U.S. Cl. CPC B32B 7/08

(57) ABSTRACT

A geometric structural assembly includes a plurality of panels. Each of the plurality of panels may be manipulated. Each of the panels comprises a plurality of sets of hinged sections. The sets of hinged sections corresponding to each of the panels are hingedly coupled together. Thus, each of the panels may be manipulated into a selected two dimensional geometric shape. Each of the plurality of panels is movably coupled together. Thus, the plurality of panels may be manipulated into a selected three dimensional geometric shape.

### BACKGROUND OF THE DISCLOSURE

### Field of the Disclosure

The disclosure relates to structural devices and more particularly pertains to a new structural device for modeling a selected three dimensional shape.

### SUMMARY OF THE DISCLOSURE

An embodiment of the disclosure meets the needs presented above by generally comprising a plurality of panels. Each of the plurality of panels may be manipulated. Each of the panels comprises a plurality of sets of hinged sections. The sets of hinged sections corresponding to each of the panels are hingedly coupled together. Thus, each of the panels may be manipulated into a selected two dimensional geometric shape. Each of the plurality of panels is movably coupled together. Thus, the plurality of panels may be manipulated into a selected three dimensional geometric shape.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a geometric structural assembly according to an embodiment of the disclosure.

FIG. 2 is a perspective view of an embodiment of the disclosure.

FIG. 3 is a perspective in-use view of an embodiment of the disclosure.

FIG. 4 is a cross sectional view taken along line 4-4 of FIG. 2 of an embodiment of the disclosure.

FIG. 5 is a bottom view of an embodiment of the disclosure.

### DESCRIPTION OF THE PREFERRED EMBODIMENT

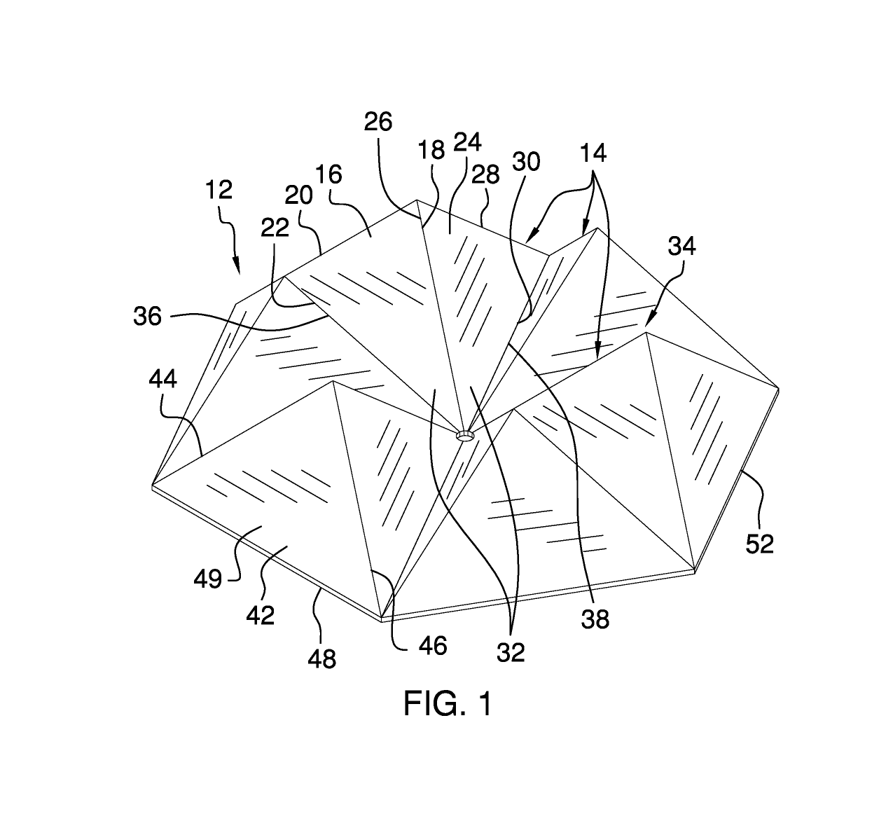

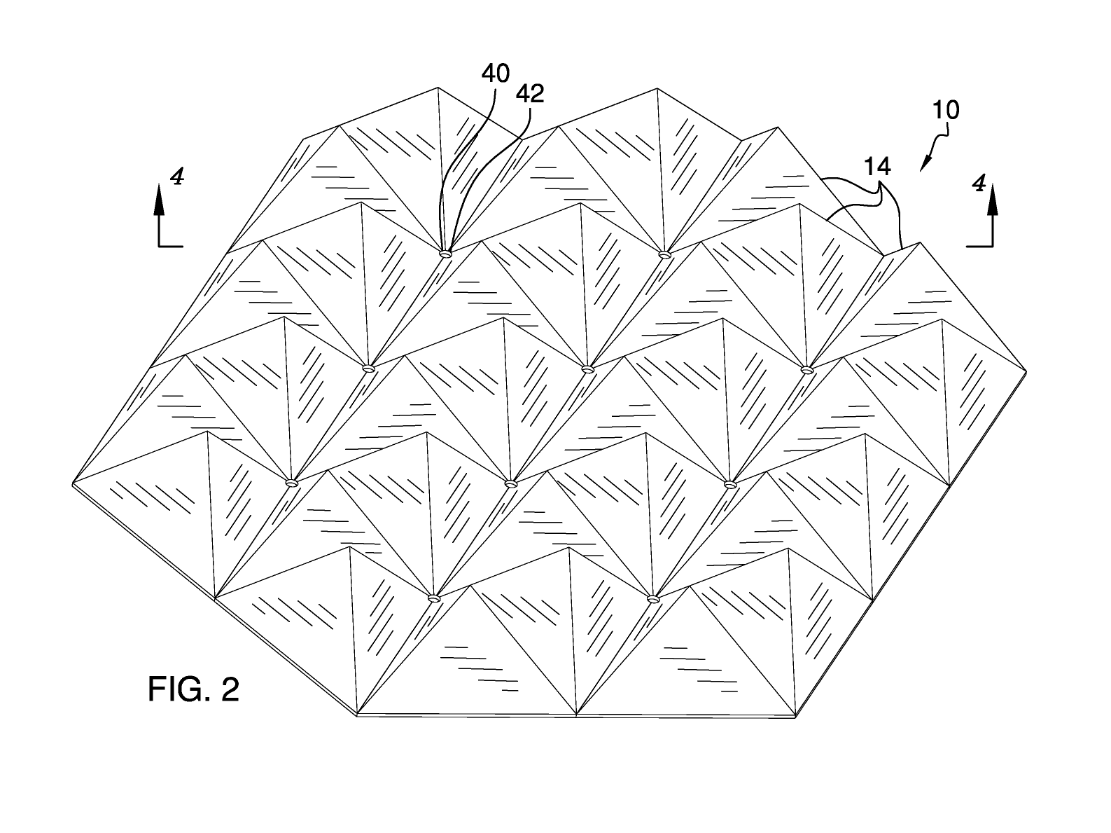

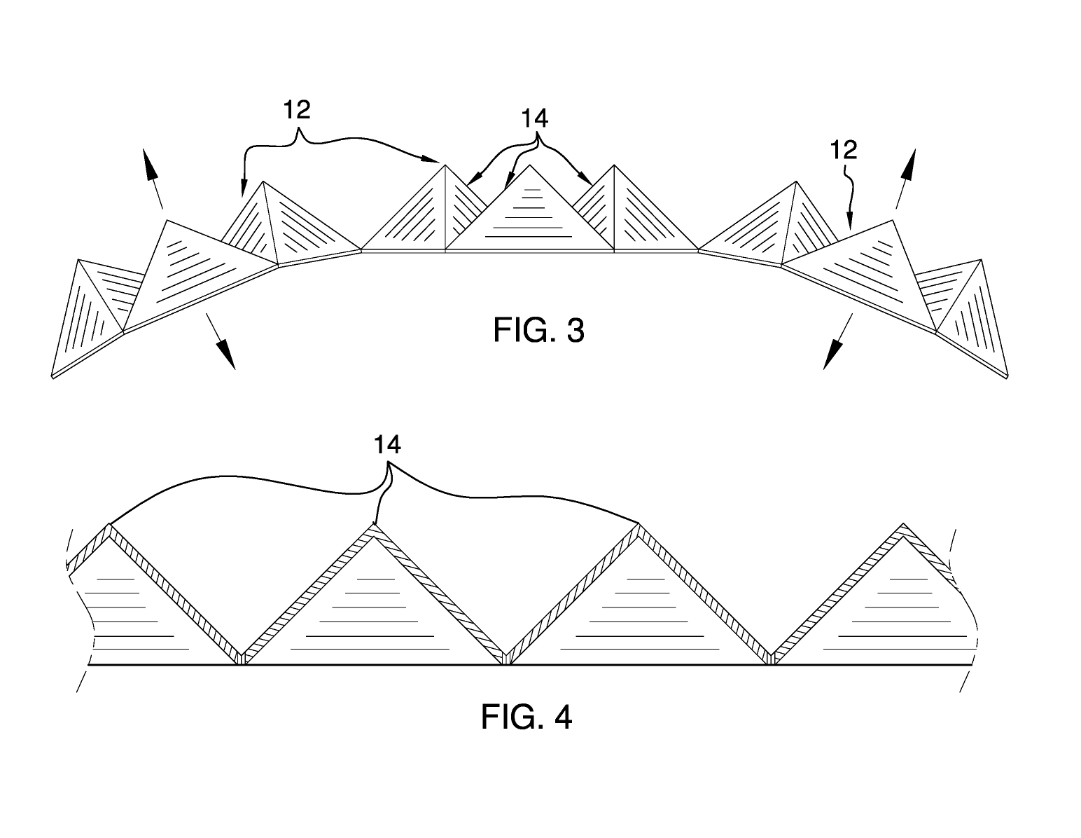

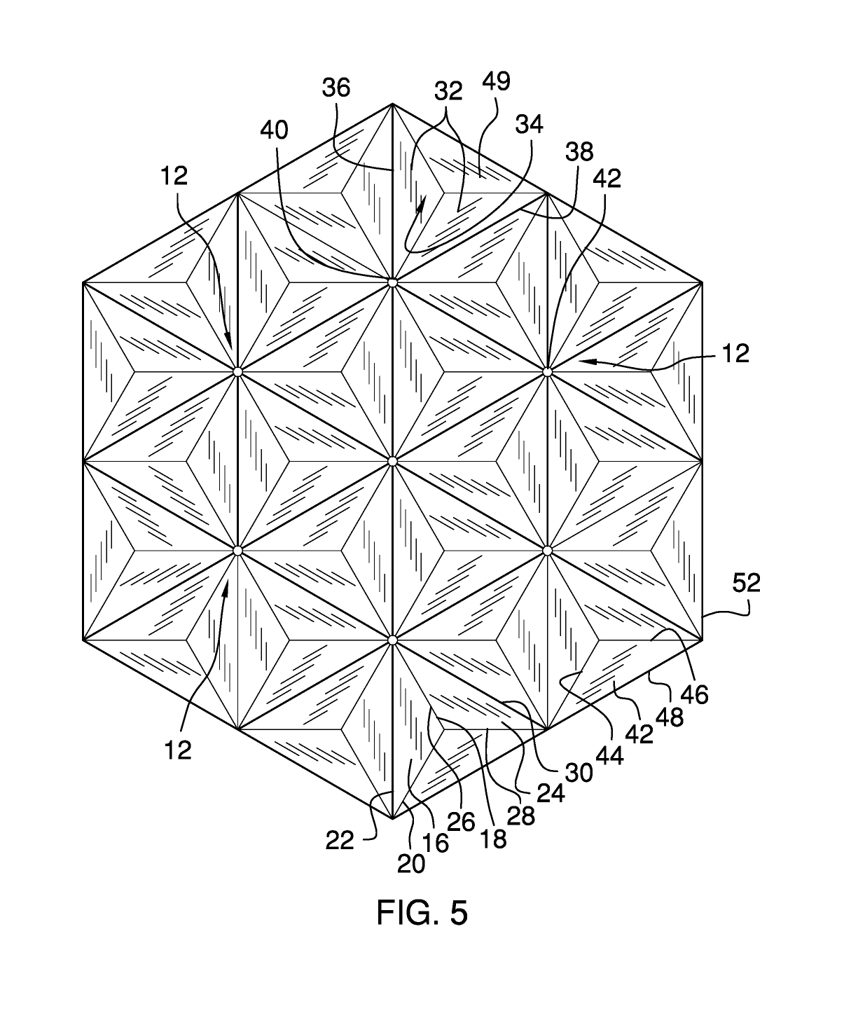

With reference now to the drawings, and in particular to FIGS. 1 through 5 thereof, a new structural device embodying the principles and concepts of an embodiment of the disclosure and generally designated by the reference numeral 10 will be described.

As best illustrated in FIGS. 1 through 5, the geometric structural assembly 10 generally comprises a plurality of panels 12 and each of the plurality of panels 12 may be manipulated. Each of the panels 12 comprises a plurality of sets of hinged sections 14. The sets of hinged sections 14 corresponding to each of the panels 12 are hingedly coupled together. Thus, each of the panels 12 may be manipulated into a selected two dimensional geometric shape. Each of the plurality of panels 12 is movably coupled together. Thus, the plurality of panels 12 may be manipulated into a selected three dimensional geometric shape.

Each of the sets of hinged sections 14 comprises a first interior panel 16 that has a first intersecting edge 18, a second intersecting edge 20 and a third intersecting edge 22. Thus, the first interior panel 16 has a triangular shape. The first interior panel 16 may be comprised of a rigid material.

A second interior panel 24 is provided. The second interior panel 24 has a first intersecting edge 26, a second intersecting edge 28 and a third intersecting edge 30. Thus, the second interior panel 24 has a triangular shape. The second interior panel 24 may be comprised of a rigid material.

The first intersecting edge 30 of the second interior panel 24 is hingedly coupled to the first intersecting edge 18 of the first interior panel 16. Thus, each of the first interior panel 16 and the second interior panel 24 defines a pair of lateral faces 32 of a pyramid 34. The third intersecting edge 22 of the first interior panel 16 defines a first lower edge 36 of the pyramid 34. The third intersecting edge 30 of the second interior panel 24 defines a second lower edge 38 of the pyramid 34. Moreover, the first lower edge 36 and the second lower edge 38 intersect to form an innermost point 40 of the pyramid 34.

An outer panel 42 is provided that has a first intersecting edge 44, a second intersecting edge 46 and a third intersecting edge 48. Thus, the outer panel 42 has a triangular shape. The first intersecting edge 44 of the outer panel 42 is hingedly coupled to the second intersecting edge 20 of the first interior panel 16. The second intersecting edge 46 of the outer panel 42 is hingedly coupled to the second intersecting edge 28 of the second interior panel 24. Thus, the outer panel 42 defines a rear face 49 of the pyramid 34. The third intersecting edge 48 of the outer panel 42 defines a third lower edge 50 of the pyramid 34.

The first lower edge 36 of each of the hinged sections 14 is hingedly coupled to the second lower edge 38 of an adjacent one of the hinged sections 14. Thus, the third lower edge 50 of each of the hinged sections 14 defines a perimeter edge 52 of an associated one of the panels 12. The hinged sections 14 of each of the panels 12 are oriented such that each of the panels 12 has a hexagonal shape. The innermost point 40 of each of the pyramids 28 is aligned with each other. The innermost point 40 of each of the pyramids 28 is spaced apart from each other to define an opening 42 in each of the panels 12. The perimeter edge 52 of each of the panels 12 is hingedly coupled together to form a sheet. Thus, each of the plurality of panels 12 may be manipulated into the selected three dimensional shape.

In use, panels 12 are manipulated to position the panels 12 in the selected three dimensional shape. The panels 12 facilitate an architectural presentation or other presentation involving the visual communication of three dimensional shapes. The panels 12 are positionable in a three dimensional shape lying a plane. The panels 12 are positionable in a spherical three dimensional shape.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A geometric structural assembly being configured to be manipulated into a plurality of geometrical shapes, said assembly comprising:
a plurality of panels, each of said plurality of panels being configured to be manipulated, each of said panels comprising a plurality of sets of hinged sections, said sets of hinged sections corresponding to each of said panels being hingedly coupled together wherein each of said panels is configured to be manipulated into a selected two dimensional geometric shape, each of said plurality of panels being movably coupled together wherein said plurality of panels is configured to be manipulated into a selected three dimensional geometric shape.

2. The assembly according to claim 1, wherein each of said sets of hinged sections comprises a first interior panel having a first intersecting edge, a second intersecting edge and a third intersecting edge such that said first interior panel has a triangular shape.

3. The assembly according to claim 2, further comprising a second interior panel having a first intersecting edge, a second intersecting edge and a third intersecting edge such that said second interior panel has a triangular shape, said first intersecting edge of said second interior panel being hingedly coupled to said first intersecting edge of said first interior panel such that each of said first interior panel and said second interior panel defines a pair of lateral faces of a pyramid.

4. The assembly according to claim 3, wherein said third intersecting edge of said first interior panel defines a first lower edge of said pyramid, said third intersecting edge of said second interior panel defining a second lower edge of said pyramid, said first lower edge and said second lower edge intersecting to form an innermost point of said pyramid.

5. The assembly according to claim 3, further comprising an outer panel having a first intersecting edge, a second intersecting edge and a third intersecting edge such that said outer panel has a triangular shape, said first intersecting edge of said outer panel being hingedly coupled to said second intersecting edge of said first interior panel.

6. The assembly according to claim 5, wherein said second intersecting edge of said outer panel is hingedly coupled to said second intersecting edge of said second interior panel such that said outer panel defines a rear face of said pyramid, said third intersecting edge of said outer panel defining a third lower edge of said pyramid.

7. The assembly according to claim 4, wherein:
said pyramid has a third lower edge; and
said first lower edge of each of said hinged sections is hingedly coupled to said second lower edge of an adjacent one of said hinged sections such that said third lower edge of each of said hinged sections defines a perimeter edge of an associated one of said panels having said innermost point of each of said pyramids being aligned with each other.

8. The assembly according to claim 7, wherein said perimeter edge of each of said panels is hingedly coupled together wherein each of said plurality of panels is configured to be manipulated into the selected three dimensional shape.

9. A geometric structural assembly being configured to be manipulated into a plurality of geometrical shapes, said assembly comprising:
a plurality of panels, each of said plurality of panels being configured to be manipulated, each of said panels comprising a plurality of sets of hinged sections, said sets of hinged sections corresponding to each of said panels being hingedly coupled together wherein each of said panels is configured to be manipulated into a selected two dimensional geometric shape, each of said plurality of panels being movably coupled together wherein said plurality of panels is configured to be manipulated into a selected three dimensional geometric shape, each of said sets of hinged sections comprising:
a first interior panel having a first intersecting edge, a second intersecting edge and a third intersecting edge such that said first interior panel has a triangular shape,
a second interior panel having a first intersecting edge, a second intersecting edge and a third intersecting edge such that said second interior panel has a triangular shape, said first intersecting edge of said second interior panel being hingedly coupled to said first intersecting edge of said first interior panel such that each of said first interior panel and said second interior panel defines a pair of lateral faces of a pyramid, said third intersecting edge of said first interior panel defining a first lower edge of said pyramid, said third intersecting edge of said second interior panel defining a second lower edge of said pyramid, said first lower edge and said second lower edge intersecting to form an innermost point of said pyramid,
an outer panel having a first intersecting edge, a second intersecting edge and a third intersecting edge such that said outer panel has a triangular shape, said first intersecting edge of said outer panel being hingedly coupled to said second intersecting edge of said first interior panel, said second intersecting edge of said outer panel being hingedly coupled to said second intersecting edge of said second interior panel such that said outer panel defines a rear face of said pyramid, said third intersecting edge of said outer panel defining a third lower edge of said pyramid; and
said first lower edge of each of said hinged sections being hingedly coupled to said second lower edge of an adjacent one of said hinged sections such that said third lower edge of each of said hinged sections defines a perimeter edge of an associated one of said panels having said innermost point of each of said pyramids being aligned with each other, said perimeter edge of each of said panels being hingedly coupled together wherein each of said plurality of panels is configured to be manipulated into the selected three dimensional shape.
